(19) United States
(12) Patent Application Publication
(10) Pub. No.: US 2026/0300778 A1
(43) Pub. Date: Oct. 1, 2026

(54) SYSTEMS AND METHODS FOR DETERMINING CAPABILITY AND ESTIMATING INTENT OF A NONCOOPERATIVE OBJECT

(71) Applicant: Martian Sky Industries, LLC, Cleveland Heights, OH (US)

(72) Inventors: Douglas Marsh, Cleveland Heights, OH (US); Wei Huang, Cleveland Heights, OH (US); Eric Coghill, Cleveland Heights, OH (US); Chris Lukowski, Cleveland Heights, OH (US); Marco Stracci, Cleveland Heights, OH (US)

(21) Appl. No.: 19/631,366

(22) Filed: Mar. 27, 2026

Related U.S. Application Data
(60) Provisional application No. 63/779,656, filed on Mar. 28, 2025.

(51) Int. Cl. G06N 5/04; G06N 5/022

(52) U.S. Cl. CPC G06N 5/04; G06N 5/022

(57) ABSTRACT

The disclosed technology relates, in general, to noncooperative spacecraft capability determination and intent estimation. More particularly, the technology relates to systems and methods for analyzing, combining, and deriving data associated with a noncooperative spacecraft to provide actionable intelligence that may enable the creation of a plan of action. Embodiments of the disclosed technology include a method of estimating the intent of a noncooperative spacecraft; evaluating onboard capabilities; assessing operational behaviors; distinguishing actionable intelligence; assessing threat levels; determining confidence in data; and providing inputs to downstream decision-makers.

### CROSS REFERENCE TO RELATED APPLICATIONS

This application claims the benefit of U.S. Provisional Patent Application No. 63/779,656, titled “SYSTEMS AND METHODS FOR DETERMINING CAPABILITY AND ESTIMATING INTENT OF A NONCOOPERATIVE SPACECRAFT,” filed on Mar. 28, 2025, the disclosure of which is hereby incorporated in its entirety.

### BACKGROUND

Determining capabilities and estimating intent of noncooperative spacecrafts in outer space may be critical. Supplying useful data that can combine with other information can increase domain awareness, proactively evaluate threats, determine threat levels, create actionable intelligence, build potential courses of action, deter future acts of aggression, and maintain safety and security for space assets.

For reasons stated above, and for other reasons which can become apparent to those skilled in the art upon reading the present specification, there is a need for systems and methods that increase understanding of the capability and intent of a noncooperative spacecraft. There is a particular need for combining knowledge of onboard systems with tracked maneuvers to better define operational and potential activities. The disclosed technology fulfills these and other needs, and addresses deficiencies in known systems and techniques.

### BRIEF DESCRIPTION OF THE DRAWINGS

The accompanying drawings, which are incorporated into and form a part of the specification, schematically illustrate one or more example implementations of the disclosed inventive subject matter and, together with the general description given above and detailed description given below, serve to explain the principles of the disclosed subject matter, and wherein:

FIG. 1 depicts a flowchart of an exemplary set of parameters that define spacecraft intent;

FIG. 2 depicts a flowchart of an exemplary set of noncooperative spacecraft intent estimation parameters including subsystem capabilities that may comprise the spacecraft operational capabilities and actual and trend data that may form a spacecraft behavioral profile;

FIG. 3 depicts an exemplary expanded breakdown of the set of noncooperative spacecraft intent estimation parameters of FIG. 2 further comprising considerations that may be categorically impactful to the elements feeding into operational capabilities and spacecraft behaviors;

FIG. 4 depicts a flowchart of an exemplary set of steps to estimate intent based on sensor data, fused data, and/or information being assessed from FIGS. 1-3;

FIG. 5 depicts another flowchart of an exemplary set of steps to estimate intent based on sensor data;

FIG. 6 depicts an exemplary set of steps taken to identify actionable intelligence by analyzing capability determination, behavioral observations, and intent estimation;

FIG. 7 illustrates an exemplary embodiment of one or more long range sensor systems that may acquire sensor data of a noncooperative craft; and

FIG. 8 illustrates an exemplary embodiment of a short-range sensor that may acquire sensor data of a noncooperative craft.

### DETAILED DESCRIPTION

Various non-limiting embodiments of the present disclosure are now described to provide an overall understanding of the principles of the structure, function, and use of the systems and methods as disclosed herein. One or more examples of these non-limiting embodiments are illustrated in the accompanying drawings. Those of ordinary skill in the art may understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment can be included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components.

The examples discussed herein are examples only and are provided to assist in the explanation of the systems and methods described herein. None of the features or components shown in the drawings or discussed below should be taken as mandatory for any specific implementation of any of these systems and methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination cannot be possible. Also, for any methods described, regardless of whether the method can be described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Estimation of intent may represent a prediction of future behavior based on an assessment of operator goals, craft capability, current behavior, and/or previous behavior. A spacecraft behavior may be any observable action or inaction and/or pattern of action or inaction taken by a spacecraft. Spacecraft capabilities may be the set of design functions of a spacecraft that can be used independently or collectively to execute behaviors in space. A spacecraft may be defined as any satellite, vehicle, or device that is operating in, from, to, or through space. Spacecrafts in space may have known, assumed, or entirely unknown capabilities and mission intent. Spacecrafts can pose a certain level of threat to other objects in space, be used beyond the nominal purpose of the spacecraft, or contain hidden or previously unknown payloads, among other potential off-nominal activities. Analyzing historical data references along with sensed data can allow for a greater understanding of potential actions that a spacecraft may be capable of performing. Better defining of achievable activities in noncooperative spacecrafts can lead to defined courses of action for an observer that can improve safety and deter threats that exist beyond the expected actions of that craft.

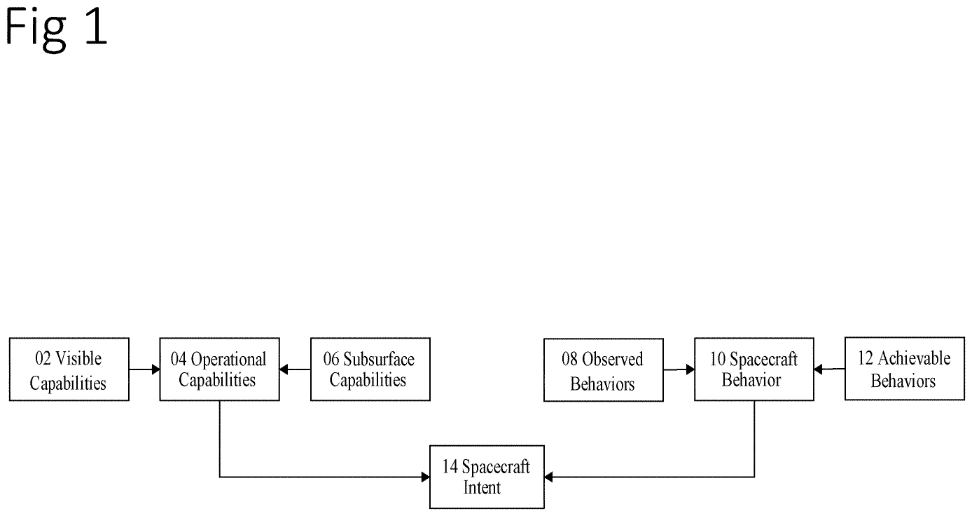

FIG. 1 depicts a flowchart of an exemplary set of parameters that define spacecraft intent (14). Operational capabilities (04) may be visible (02) or contained within the spacecraft as subsurface capabilities (06). Spacecraft behavior (10) may include observed behaviors (08) and/or achievable behaviors (12). A combined capability and behavior profile may be used to define spacecraft intent (14), where operational and behavioral characteristics (04, 10) can be used to determine the achievable limits for the spacecraft.

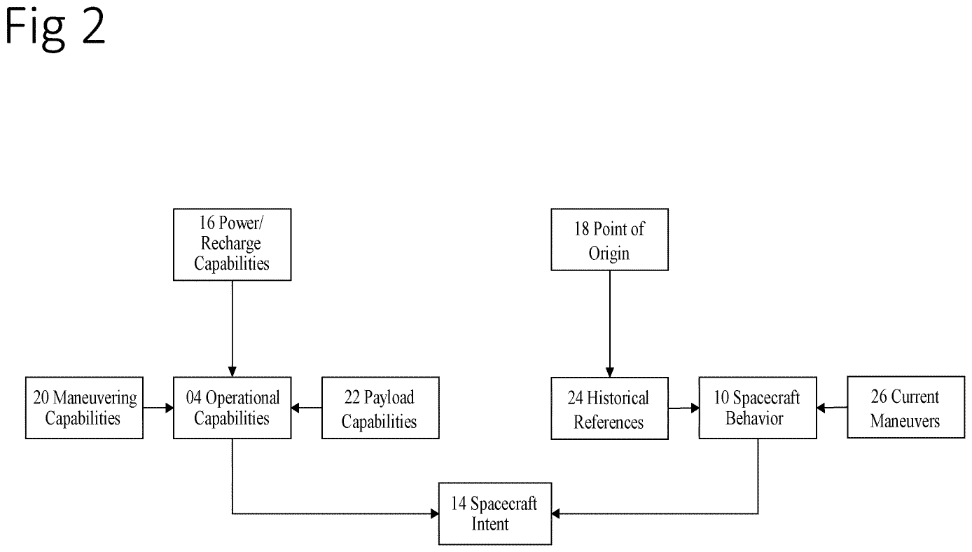

FIG. 2 depicts a flowchart of an exemplary set of noncooperative spacecraft intent estimation parameters including subsystem capabilities that may comprise spacecraft operational capabilities (04) and actual and trend data that may form a spacecraft behavioral profile. Operational capabilities (04) may include maneuvering capabilities (20), power/recharge capabilities (16), and payload capabilities (22). Spacecraft behaviors (10) may include current maneuvers (26) that are observed, previous historical references (24) that can be attributed to the spacecraft, collection of spacecrafts, or known similar configurations of previously operational spacecrafts. Historical references (24) may be further aligned with point of origin (18) data that can be attributed to where the system has been built, what parts are or may be used in construction, how and where the craft was deployed to space, known orbital dynamics data for the spacecraft, collection of spacecrafts, or known similar configurations of previously operational spacecrafts.

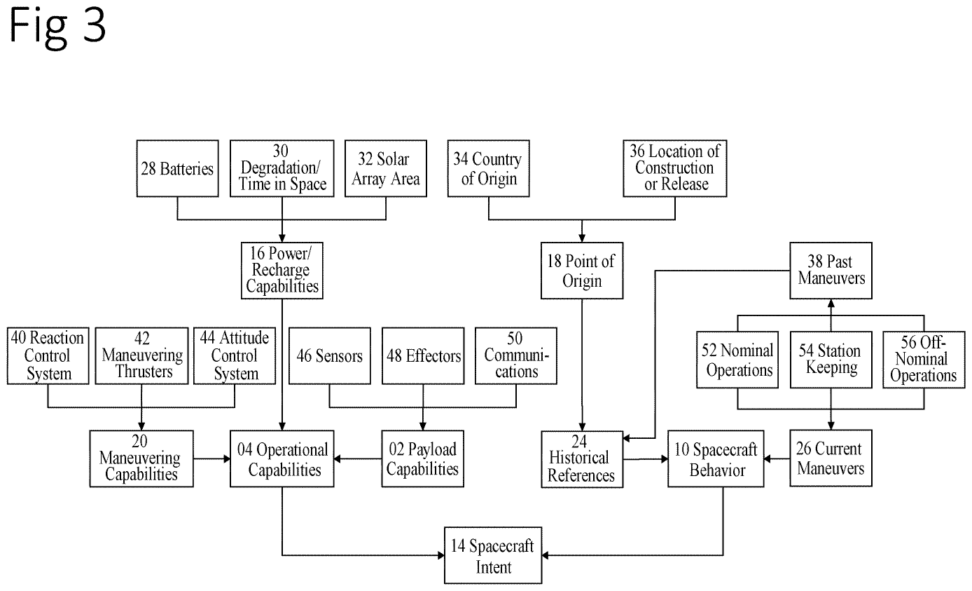

FIG. 3 depicts an exemplary expanded breakdown of the set of noncooperative spacecraft intent estimation parameters of FIG. 2 further comprising considerations that may be categorically impactful to the elements feeding into operational capabilities (04) and spacecraft behaviors (10). Maneuvering capabilities (20) may consist of a reaction control system (40), maneuvering thrusters (42), and/or an attitude control system (44). Power/recharge capabilities (16) may consist of batteries (28), degradation/time in space (30) that may inform a reduction in power efficiency, and/or an overall solar array area (32) which can be used to determine onboard power storage and generation capacity. Payload capabilities can consist of sensors (46), effectors (48), and/or onboard communications (50) equipment, such as antennas. Systems described may include visible capabilities (02) or subsurface capabilities (06). Sensing modalities that may identify the visible capabilities (02) or subsurface capabilities (06) that can make up the operational capabilities (04) are likely to vary. Spacecraft behaviors (10) can consist of observed behaviors (08) and/or achievable behaviors (12) that may include standard station keeping (54), information acquired based on nominal operations (52), or off-nominal operations (56). Off-nominal operations (56) may be defined as any operation that may be performed outside of the normal assumed duty of the spacecraft, which can include deployment of structures, sudden maneuvers, orbital changes, collision avoidance, movement beyond safe accepted orbital bounds of other crafts, fixing the craft orientation, prolonged positioning, end of life maneuvers, or other maneuvers. Nominal operations (52), station keeping (54), and/or off-nominal operations (56) can be tracked over time to create data for past maneuvers (38) that can feed into historical references (24). Historical references (24) may further consist of point of origin (18) information, such as country of origin (34) and/or location of construction or release (36), ground or space. The combination of current maneuvers (26) and historical references (24) may describe a spacecraft behavior (10) profile that, along with the defined operational capabilities (04), provides information that indicates the spacecraft intent (14).

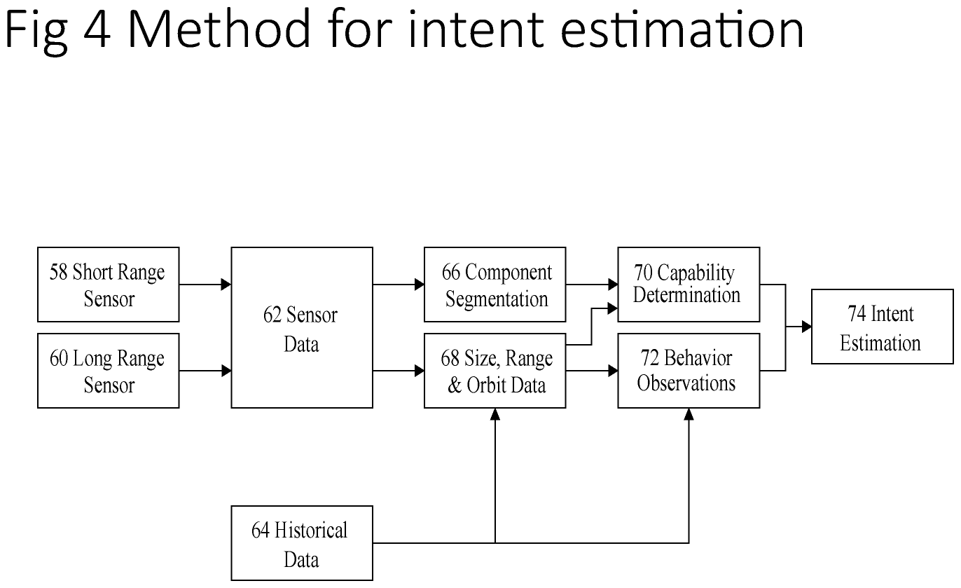

FIG. 4 depicts a flowchart of an exemplary set of steps to estimate intent based on sensor data, fused data, and/or information being assessed from FIGS. 1-3. This method may combine a short-range sensor (58) and/or long-range sensor (60) that may yield sensor data (62) and historical data (64) references to construct intent estimations (74). The short-range sensor (58) and long-range sensor (60) may consist of one or more of the same or different sensing devices operating in the same or different wavelength. Sensor data (62) may be treated separately or combined as fused data. Fused data may be data integrated from multiple data sources to produce more consistent, accurate, and useful information than that provided by any individual source. One or more sets of sensor data (62) from short-range sensor (58) and/or long-range sensor (60) may be used to assess operational capabilities (04), spacecraft behavior (10), and/or spacecraft intent (14). Sensor data (62) can be used to perform component segmentation (66). Component segmentation (66) may be the identification of geometrically distinct portions of an observed object. Historical data (64), if available, may be analyzed with sensor data (62) to determine size, range, and orbit data (68) for the observed craft. Behavior observations (72) can be collected with the benefit of historical data (64) or initiated to build historical data (64) needed to potentially improve intent estimation (74). Size, range, and orbit data (68) may also be analyzed with component segmentation (66) data to build a capability determination (70). Size data from (68) may include the magnitude of the physical measurements of the spacecraft. Range date from (68) may include the relative distance between the spacecraft and a sensor or reference object. Orbit data from (68) can consist of orbital elements or knowns in regard to position, navigation, timing, and/or movement of the spacecraft. Spacecraft capability determination (70), in combination with behavior observations (72) may increase understanding of the spacecraft intent (14) through intent estimation (74).

Sensors operating as short-range sensor (58) and/or long-range sensor (60) may be designed to process a signal generated onboard an observing system or to interpret a signal created by a noncooperative spacecraft being assessed for intent estimation (74). In this instance, sensors may include both a sensor and a detector based on the required data to form intent estimation (74). Sensor data (62) may include one or more sets of imagery or signals. In one or more embodiments, sensors may be selected from the group consisting of optical telescopes, reflecting telescopes, refracting telescopes, radio telescopes, the Hubble Space Telescope, the Chandra X-ray Observatory, the Spitzer Space telescope, the James Webb Space Telescope, the Geostationary Operational Environmental Satellite, satellites for planetary exploration, robotic probes and landers, ground-based observatories, amateur telescopes, adaptive optics systems, infrared detectors, ultraviolet detectors, x-ray imagers, LiDAR sensors, space telescope imaging spectrograph, cameras, video-cameras, neuromorphic sensors, and/or spacecraft cameras. In one or more embodiments, the sensors may include a signal processing sensor, which may be selected from a set that reads or identifies radio frequency signals, reflective signals, active sensor signals, identifiable passive signals, optical communications, communicative maneuvers, and/or use of other signals for determining capabilities and estimating intent.

Following the collection of sensor data (62), a processor may receive said sensor data (62) and process said sensor data (62) such that datasets from one or more combinations of short-range sensors (58) and long-range sensors (60) may be usable to estimate spacecraft intent (14). The processor may exist on the ground or in space. An in-space processor may exist onboard an observing spacecraft. A remote processor may exist independently from where data is being collected, either on the ground or in space. In one or more embodiments, the processor may be selected from the group consisting of a central processing unit, a graphics processing unit, a microprocessor, a media processor, a tensor processing unit, a field-programmable gate array, a system-on-chip, an application-specific integrated circuit, a multi-core processor, a neural processing unit, a quantum processor, a three-dimensional processor, a cloud-based processor, and/or other processor. In one or more embodiments, central processing units and graphics processing units are utilized for processing data close to the sensor, which may be a processor in an integrated architecture with the sensor or within proximity to that system such that data can be processed at a rate at or near which data may be incoming.

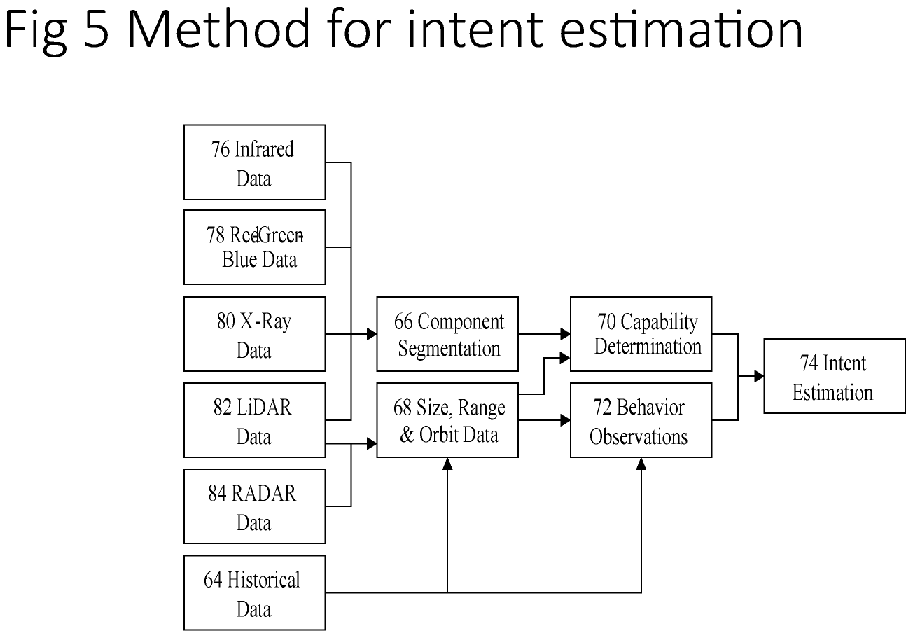

FIG. 5 depicts another flowchart of an exemplary set of steps to estimate intent based on sensor data that may be used to inform component segmentation (66) and properties such as size, range, and orbit data (68). Sensor data (62) may be in the form of infrared data (76), red-green-blue data (78), x-ray data (80), LiDAR data (82), and/or other data that may aid in performing component segmentation (66). Similarly, LiDAR data (82) and/or RADAR data (84) may be combined with historical data (64) to assess size, range, and orbit data (68) which in combination with component segmentation (66), may inform capability determination (70). Size, range, and orbit data (68) can also be used to build historical data (64) or be used to compare to known spacecraft behavior (10). Behavior history (72) and capability determination (70) may also be used to inform intent estimation (74) for noncooperative crafts.

Sensor data (62) can be processed through a processor and may come in two-dimensional or three-dimensional forms. Two-dimensional data may include red-green-blue imagery, spectral imagery, multi-spectral imagery, bands of hyperspectral imagery, histograms occurring in one or more two-dimensional arrays, and/or other imagery. Three-dimensional data may comprise a point cloud, a point set, a list of points in three-dimensional space, a depth map, a set of surfels, a triangle mesh, a polygon mesh, a three-dimensional grid of cubic voxels, a three-dimensional grid of polyhedral voxels, a three-dimensional spectrum map, or other three-dimensional data. The processor may use two-dimensional and/or three-dimensional sensor data (064) for performing intent estimation (074).

Observations can lead to complete or partial capability determination (70) for a noncooperative spacecraft. Even with all systems and subsystems known in complete capability determination (70), intent estimation (74) may be the highest achievable prospect for predicting future behavior of a noncooperative craft. Complete or partial capability determination (70) may supply enough information for viable intent estimation (74) without the need for behavior observations (72). Similarly, behavior observations (72) may supply enough information for intent estimation (74) without the need for capability determination (70). The combination of onboard operational capabilities (04) and spacecraft behaviors (10) in a noncooperative spacecraft may be attributable to multiple potential future behaviors that can be presented with multiple confidence levels.

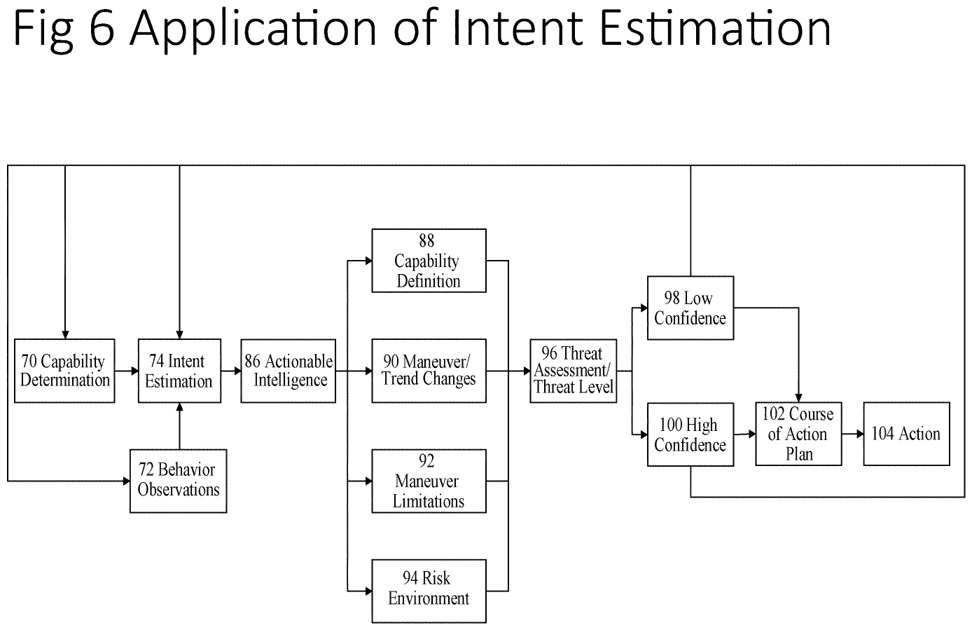

FIG. 6 depicts an exemplary set of steps taken to identify actionable intelligence (86) by analyzing capability determination (70), behavioral observations (72), and intent estimation (74). Actionable intelligence (86) may include any data or information that can be used, transitioned into coherent insights, and/or acted upon as a result of data analytics or similar assessment methods for decision-making. Assessment methods may include statistical analysis or machine learning. Machine learning may include the use and development of computer systems that are able to learn and adapt without following explicit instructions, by using algorithms and statistical models to analyze and draw inferences from patterns in data. Actionable intelligence (86) can include capability definition (88), maneuver/trend changes (90), maneuver limitations (92), and/or risk environment (94). Capability definition (88) may be information on capabilities identified during capability determination (70). Maneuver/trend changes (90) may include historical data (64) for reference and comparison of data acquired during observation that shows an off-nominal (56) pattern that may be distinct from nominal operations (52) or station keeping (54). Maneuver limitations (92) may be determined in the capability determination (70) where operational capabilities (04) supply the limiting bounds of the spacecraft behavior (10) based on craft systems. Risk environment (94) may combine point of origin (18) evidence or knowledge with information on current geopolitical conditions. The information on current geopolitical conditions may include user input. Capability definition (88), maneuver/trend changes (90), maneuver limitations (92), and/or risk environment (94) may be combined into an overall threat assessment/threat level (96). Threat assessment/threat level (96) may account for confidence levels and assurances across all available actionable intelligence (86) to determine if there may be a low confidence (98) or high confidence (100) threshold in the threat assessment/threat level (96). Low confidence (98) threats can be reanalyzed for capability determination (70), behavior observations (72), and intent estimation (74) to achieve high confidence (100) in the threat assessment/threat level (96). Low confidence (98) threat assessment/threat level (96) information can be used to form a course of action plan (102) in the event that actionable intelligence (86), such as the risk environment (94), escalates or changes before sufficient capability determination (70), behavior observations (72), or intent estimation (74) information can be used to elevate low confidence (98) information into high confidence (100) assessments. Low confidence (98) and/or high confidence (100) information can be used to formulate course of action plan (102) that allows for the selection of a downstream action (104). High confidence (100) data, similarly to low confidence (98) data, continues to be fed into the capability determination (70), behavior observations (72), or intent estimation (74) to update assessments as new data becomes available.

Course of action plan (102) may suggest downstream action (104) to take in response to threat assessment/threat level (96) based on low confidence (098) and high confidence (100) threat assessment/threat level (96). Course of action plan (102) may include a single or multiple choices for downstream action (104) to take based on threat assessment/threat level (96). Often, in most cases of low confidence (98) solution, downstream action (104) chosen may be inaction, which may be a reason for feeding low confidence (98) solutions back into capability determination (70), behavior observations (72), and intent estimation (74). The information may be used to contribute to historical data (64) that may assist in building high confidence (100) assessments.

Course of action plan (102) may be evaluated by a decision-maker, either a human or autonomous system, to select downstream action (104). Higher risk environment (94) may require an action taken from low confidence (98) course of action plan (102). The decision-maker must define or choose threat assessment/threat level (96) and confidence threshold that requires final downstream action (104) to be chosen and enacted. Time to action may be a potential factor in the decision to choose downstream action (104) from low confidence (98) course of action plan (102). Course of action plan (102) may score and rank each downstream action (104) based on the expected intent of the noncooperative spacecraft and the confidence achieved in the system.

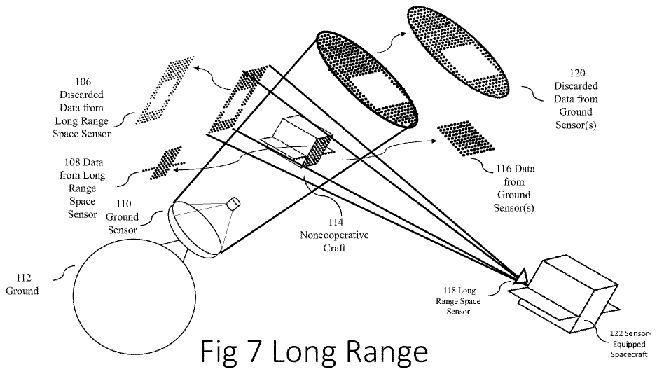

FIG. 7 provides an illustration of an exemplary embodiment of one or more long range sensor (060) systems that may acquire sensor data (62) of a noncooperative craft (114). Long-range sensor (60) may include a ground sensor (110) on or near ground (112) and/or a long-range space sensor (118) on a sensor-equipped spacecraft (122) in space. Data from a ground sensor (116) and/or data from a long-range space sensor (108) may be representative of sensor data (62) used for intent estimation (74). Discarded data from a ground sensor (120) and discarded data from a long-range space sensor (106) represents sensor data (62) that may not be used for intent estimation (74).

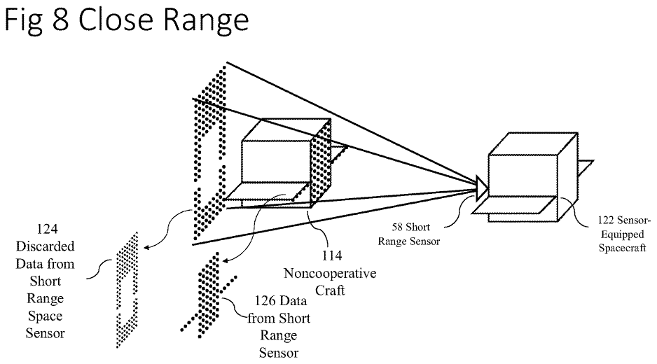

FIG. 8 provides an illustration of an exemplary embodiment of short-range sensor (58) that may acquire sensor data (62) from noncooperative craft (114). Short-range sensor (58) may be mounted to sensor-equipped spacecraft (122). Data from a short-range sensor (126) can be representative of sensor data (62) used for intent estimation (74). Discarded data from short range sensor (124) may represent sensor data (62) that may not be used for intent estimation (74).

Sensor data (62) that may be used for capability determination (70), behavior observations (72), and intent estimation (74) may include data from long-range space sensor (108), data from ground sensor (116), data from short-range sensor (58), and/or other sensors.

Sensor data (62) that may not be used for intent estimation (74) may be used to build an understanding of the surrounding environment or supply other information about what may or may not be occurring within the field of view of the sensor. While sensor data (62) may not be considered as actionable intelligence (86) in regard to performing intent estimation (74) for noncooperative craft (114), broader awareness may be obtained from such information.

The following examples relate to various non-exhaustive ways in which the teachings herein may be combined or applied. The following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

Example 1 may be a system for noncooperative spacecraft intent estimation comprising: one or more sensing devices configured to generate noncooperative spacecraft capabilities and behaviors data; a processor configured to: receive noncooperative spacecraft capabilities and behaviors data from said one or more sensing devices; determine capabilities of a noncooperative spacecraft; collect behavior observations of the noncooperative spacecraft; and estimate the noncooperative spacecraft's intent.

Example 2 may be the system according to Example 1, wherein said one or more of said sensing devices are further configured to produce a set of data indicating subsurface capabilities within said noncooperative spacecraft.

Example 3 may be the system according to Example 1, wherein said one or more of said sensing devices are further configured to produce a set of two-dimensional data indicating said capabilities and behaviors of the noncooperative spacecraft.

Example 4 may be the system according to Example 1, wherein said one or more of said sensing devices are further configured to produce a set of three-dimensional data indicating said capabilities and behaviors of the noncooperative spacecraft.

Example 5 may be the system according to Example 1, wherein said processor is further configured to combine multiple datasets from said one or more sensing devices into a structured output.

Example 6 may be the system according to Example 1, wherein said processor is further configured to identify trends for improved analyses by analyzing historical data.

Example 7 may be the system according to Example 1, wherein said processor is further configured to assess confidence in intent estimation.

Example 8 may be the system according to Example 7, wherein said processor is further configured to determine capabilities using data from said sensing devices through machine learning.

Example 9 may be a method for noncooperative spacecraft intent estimation, the method comprising: creating one or more datasets of one or more observations of one or more noncooperative spacecrafts; determining one or more onboard capabilities of one or more noncooperative spacecrafts based on collected observations; observing spacecraft behavior for one or more noncooperative spacecrafts; and determining an intent estimation based on the capability determination and the behavior observations.

Example 10 may be the method according to Example 9, further comprising deriving actionable intelligence from intent estimation.

Example 11 may be the method according to Example 9, further comprising assessing a confidence in said intent estimation based on a statistical model.

Example 12 may be the method according to Example 11, further comprising reassessing low and high confidence data.

Example 13 may be the method according to Example 9, further comprising identifying capabilities of a noncooperative spacecraft from sensor data through machine learning.

Example 14 may be the method according to Example 9, further comprising storing the one or more observations of one or more noncooperative spacecrafts as historical data.

Example 15 may be the method according to Example 14, wherein determining an intent estimation is further based on historical data.

Example 16 may be the method according to example 9, further comprising aligning data from one or more sensing devices based on knowledge of sensor intrinsics and extrinsics.

Example 17 may be the method according to Example 9, wherein said intent estimation is formulated using patterns of observed behavior.

Example 18 may be the method according to Example 17, further comprising deriving intent estimation based on patterns of observed behavior through machine learning.

Example 19 may be the method according to Example 9, wherein said intent estimation is formulated using identified capabilities for which corresponding behaviors have not been observed.

Example 20 may be the method according to Example 9, wherein determining an intent estimation is further based on knowledge of the point of origin.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein can be combined would be readily apparent to those of ordinary skill in the art in view of the teachings herein. Such modifications and variations are intended to be included within the scope of the claims.

Having shown and described various embodiments of the present disclosure, further adaptations of the methods and systems described herein may be accomplished by appropriate modifications by one of ordinary skill in the art without departing from the scope of the present disclosure. Several such potential modifications have been mentioned, and others can be apparent to those skilled in the art. For instance, the examples, embodiments, geometrics, materials, dimensions, ratios, steps, and the like discussed above are illustrative and are not required. Accordingly, the scope of the present disclosure should be considered in terms of the following claims and should be understood not to be limited to the details of structure and operation shown and described in the specification and drawings.

What is claimed:

1. A system for noncooperative spacecraft intent estimation comprising:
a. one or more sensing devices configured to generate noncooperative spacecraft capabilities and behaviors data; and
b. a processor configured to:
i. receive noncooperative spacecraft capabilities and behaviors data from said one or more sensing devices;
ii. determine capabilities of a noncooperative spacecraft;
iii. collect behavior observations of the noncooperative spacecraft; and
iv. estimate the noncooperative spacecraft's intent.

2. The system according to claim 1, wherein said one or more of said sensing devices are further configured to produce a set of data indicating subsurface capabilities within said noncooperative spacecraft.

3. The system according to claim 1, wherein said one or more of said sensing devices are further configured to produce a set of two-dimensional data indicating said capabilities and behaviors of the noncooperative spacecraft.

4. The system according to claim 1, wherein said one or more of said sensing devices are further configured to produce a set of three-dimensional data indicating said capabilities and behaviors of the noncooperative spacecraft.

5. The system according to claim 1, wherein said processor is further configured to combine multiple datasets from said one or more sensing devices into a structured output.

6. The system according to claim 1, wherein said processor is further configured to identify trends for improved analyses by analyzing historical data.

7. The system according to claim 1, wherein said processor is further configured to assess confidence in intent estimation.

8. The system according to claim 1, wherein said processor is further configured to determine capabilities using data from said sensing devices through machine learning.

9. A method for noncooperative spacecraft intent estimation, the method comprising:
a. creating one or more datasets of one or more observations of one or more noncooperative spacecrafts;
b. determining one or more onboard capabilities of one or more noncooperative spacecrafts based on collected observations;
c. observing spacecraft behavior for one or more noncooperative spacecrafts; and
d. determining an intent estimation based on the capability determination and the behavior observations.

10. The method according to claim 9, further comprising deriving actionable intelligence from intent estimation.

11. The method according to claim 9, further comprising assessing a confidence in said intent estimation based on a statistical model.

12. The method according to claim 11, further comprising reassessing low and high confidence data.

13. The method according to claim 9, further comprising identifying capabilities of a noncooperative spacecraft from sensor data through machine learning.

14. The method according to claim 9, further comprising storing the one or more observations of one or more noncooperative spacecrafts as historical data.

15. The method according to claim 14, wherein determining an intent estimation is further based on historical data.

16. The method according to claim 9, further comprising aligning data from one or more sensing devices based on knowledge of sensor intrinsics and extrinsics.

17. The method according to claim 9, wherein said intent estimation is formulated using patterns of observed behavior.

18. The method according to claim 17, further comprising deriving intent estimation based on patterns of observed behavior through machine learning.

19. The method according to claim 9, wherein said intent estimation is formulated using identified capabilities for which corresponding behaviors have not been observed.

20. The method according to claim 9, wherein determining an intent estimation is further based on knowledge of the point of origin.
